(19) United States
(12) Patent Application Publication
(10) Pub. No.: US 2015/0277728 A1
(43) Pub. Date: Oct. 1, 2015

(54) METHOD AND SYSTEM FOR AUTOMATICALLY SELECTING PARAMETERS OF INTERFACE OBJECTS VIA INPUT DEVICES

(71) Applicant: ABBYY Development LLC, Moscow (RU)

(72) Inventor: Sergey Anatolyevich Kuznetsov, Moscow Region (RU)

(21) Appl. No.: 14/571,804

(22) Filed: Dec. 16, 2014

(30) Foreign Application Priority Data
Mar. 31, 2014 (RU) 2014112238

(51) Int. Cl. G06F 3/0484; G06F 3/0482

(52) U.S. Cl. CPC G06F 3/04847; G06F 3/04842; G06F 3/0482

(57) ABSTRACT

A method of automatically selecting a set of parameters of an action performed by a user with the help of an input device is presented. The set of parameters is defined based on the steps of a continuous user's action. The selected set of parameters corresponds to a number of settings of an interface tool of a computer program. The interface, by acting upon the program interface with an input device, allows a user to control a response of the computer program. The automatically selected set of parameters is can control the properties of a selected interface tool, as well as the type of the interface tool as defined by a continuous user action.

### CROSS REFERENCE TO RELATED APPLICATIONS

This application claims the benefit of priority under 35 USC 119 to Russian Patent Application No. 2014112238, filed Mar. 31, 2014; the disclosure of which is incorporated herein by reference.

### FIELD OF THE INVENTION

The present invention relates in general to the field of computer applications and program interfaces and, more specifically, to a selection of parameters for interacting with such interfaces and for controlling a program's response.

### BACKGROUND OF THE INVENTION

Working with a sophisticated computer program interface can be laborious and time consuming even for an experienced user. Users of sophisticated computer programs often need to learn or memorize numerous sequences of input commands, hot keys, or sequences of various moves of an input device in order to operate the program by communicating with the program's interface. The more sophisticated the programs and the tasks they perform become, the more tiring and time consuming it becomes for a user to frequently change various properties of the tools of the program's interface as needed to repeatedly input the desired commands into the interface and accomplish a desired task.

For example, in the context of optical character recognition of a selected portion of an image of a document or an object a user often needs to define a number of parameters in accordance to which an OCR program will perform its processing of the selected portion. Those parameters can be the size of the selected portion, the language of the document, the orientation of the text on a page (vertical, horizontal, at an angle), pictures within the selected portion of the image of document that does not need to be text-recognized, but could need to be image processed in a different way. In the context of image processing such parameters could be, for example, a removal of red eyes in a photo, or an alteration of a color scheme, or a change of the size of an image, or any other parameter relevant to a specific image processing task. In case of an audio or video track within the selected portion or object a user usually repeatedly selects various parameters of the tools of the interface needed to accomplish a desired processing task.

The need to repeatedly select various parameters of the interface makes the user perform repeated quick motions with an input device (a mouse, a finger on a touch pad, a finger on a touch screen) and to repeatedly search for and select numerous desired properties of the interface in toolbars, pull-down menus, and pop-up menus can become very exhausting.

### SUMMARY OF THE INVENTION

The present invention is directed to a method of automatically selecting parameters for a selected portion of an image or an object, as well as selecting tools of an interface of a computer program depending on the selected parameters. The method comprises using an input device to start an action upon the interface and selecting an interface tool corresponding to a beginning of the action; continuously acting upon the interface with the input device during the action to define a scope of the action, the scope of the action corresponding to a set of settings of the interface tool, the settings of the interface tool corresponding to the set of parameters of the action being defined by steps of the continuous action of the input device. The method furthermore comprises automatically selecting a set of parameters of the action by identifying the steps of the continuous action of the input device during the action selecting a response of a computer program, the response corresponding to the settings of the interface tool operating in accordance with the automatically selected set of parameters of the action; generating the response of the computer program, the response being controlled by the settings of the interface tool; and ending the action of the input device upon the interface.

The method additionally comprises selecting the interface tool further comprises selecting a portion of an object or a portion of a group of objects.

The method additionally comprises using the input device comprises using a peripheral device, a touch screen, a multisensory screen, an audio input, or a video input.

The method contemplates selecting the response of the computer program, wherein the computer program is a text processing program, an image processing program, an audio processing program, a video processing program, a program working with objects in a spatial reference frame, a program working with a three-dimensional model or any combinations thereof. The referenced computer program can be a CAD program.

The method further contemplates that the steps of the continuous action of the input device comprise changing an angle of a motion of the input device, changing a direction of the motion of the input device, changing a type of the motion, changing an intensity or velocity of an input of the input device, a tilt of a stylus of a graphic pad, graphic tablet, drawing tablet, or any combinations thereof.

According to the invention, the step of continuously acting upon the interface with the input device during the action can performed by a human user, or by a machine or a device.

In another aspect of the present invention a method of automatically selecting parameters for a computer program interface comprises (a) using an input device to start an action upon the interface and selecting an interface tool corresponding to a beginning of the action; (b) continuously acting upon the interface with the input device during the action to define a scope of the action, the scope of the action corresponding to a set of settings of the interface tool, the settings of the interface tool corresponding to the set of parameters of the action being defined by steps of the continuous action of the input device; (c) automatically selecting a set of parameters of action by identifying the steps of the continuous action of the input device during the action; (d) selecting a response of a computer program, the response corresponding to the settings of the interface tool operating in accordance with the automatically selected set of parameters of the action; (e) generating the response of the computer program, the response being controlled by the settings of the interface tool; and (f) ending the action of the input device upon the interface or alternatively continuing the action by selecting a different interface tool and performing steps (b)-f) for the different interface tool.

Selecting the interface tool in the inventive method comprises selecting a portion of an object or a portion of a group of objects.

The method also contemplates continuing the action by selecting a different interface tool as determined by a state of the action at a predetermined time. That predetermined time could be the time when the user either ends the action or continues it with the different tool.

The system of the present invention comprises a processor and a memory coupled to the processor, the memory comprising an application which when executed causes the system to perform a set of instructions for automatically selecting parameters of an action, the instructions comprising: using an input device to start an action upon the interface and selecting an interface tool corresponding to a beginning of the action; continuously acting upon the interface with the input device during the action to define a scope of the action, the scope of the action corresponding to a set of settings of the interface tool, the settings of the interface tool corresponding to the set of parameters of the action being defined by steps of the continuous action of the input device; automatically selecting a set of parameters of the action by identifying the steps of the continuous action of the input device during the action; selecting a response of a computer program, the response corresponding to the settings of the interface tool operating in accordance with the automatically selected set of parameters of the action; generating the response of the computer program, the response being controlled by the settings of the interface tool; and ending the action of the input device upon the interface.

In another embodiment of the system of the present invention the system comprising: a processor and a memory coupled to the processor, the memory comprising an application which when executed causes the system to perform a set of instructions for automatically selecting parameters for an action, the method comprising: (a) using an input device to start an action upon the interface and selecting an interface tool corresponding to a beginning of the action; (b) continuously acting upon the interface with the input device during the action to define a scope of the action, the scope of the action corresponding to a set of settings of the interface tool, the settings of the interface tool corresponding to the set of parameters of the action being defined by steps of the continuous action of the input device; (c) automatically selecting a set of parameters of action by identifying the steps of the continuous action of the input device during the action; (d) selecting a response of a computer program, the response corresponding to the settings of the interface tool operating in accordance with the automatically selected set of parameters of the action; (e) generating the response of the computer program, the response being controlled by the settings of the interface tool; and (f) ending the action of the input device upon the interface or alternatively continuing the action by selecting a different interface tool and performing steps (b)-(f) for the different interface tool.

The present invention is also directed to a physical, non-transitory computer storage medium having stored thereon a program which when executed by a processor, perform instructions for automatically selecting parameters of a computer program interface, the instructions comprising the sequence of the steps of the above-described inventive method.

### BRIEF DESCRIPTION FO THE DRAWING FIGURES

In the accompanying drawings, emphasis has been placed upon illustrating the principles of the invention. Nothing in the drawings should be construed as limiting the principles of the invention. Of the drawings:

FIG. 1 is a schematic illustration of an aspect of the inventive method;

FIG. 2 is a schematic illustration of an implementation of the method illustrated in FIG. 1;

FIG. 3 is a schematic illustration of yet another implementation of the method illustrated in FIG. 1;

FIG. 4 is a schematic illustration of another aspect of the inventive method;

FIG. 5 is a schematic illustration of an implementation of the method illustrated in FIG. 4;

FIG. 6 is a schematic illustration of another implementation of the method illustrated in FIG. 4;

FIG. 7 is a schematic illustration of yet another implementation of the method illustrated in FIG. 4;

FIG. 8 is an illustration showing yet another implementation of the inventive method; and

FIG. 9 is a schematic illustration of an alternative implementation of the inventive method in an OCR program.

### DETAILED DESCRIPTION OF THE INVENTION

In the context of the present invention, the terms “a” and “an” mean “at least one”.

By “action” we herein mean any type of a user input upon a program interface serving to select an object displayed or otherwise shown or presented to the user.

By “the beginning of an action” we mean pressing a button of a mouse or any other input device or means, a set of predetermined movements of a cursor (such as up-down, circular, at an angle and the like), geometrical or speed parameters of such cursor motions (for example, a quick left-to-right move, or quickly up and slow right move and so on), and/or movements of a cursor or any other input device while pressing a button and/or any other input related means of communication with the operation system.

By “the scope of an action” we mean a set of parameters of the action that are determined in accordance with the motion of a cursor or any other input means or devices from the beginning to the end of the move. Such parameters can be a point-to-point distance, a direction of the motion of a cursor or any other input means, a type of the trajectory of the motion, the speed with which a cursor or any other input device moves or otherwise inputs information, the intensity of such moves of a cursor, a tilt of a stylus of a graphic pad, graphic tablet, drawing tablet, and other related characteristics.

By “the end of the action” we mean a release or repeat pressing of an input device (for example, it could be a release or repeated pressing of the pressed button of a mouse), or removal, or disconnect, or repeated pressing of any input means (for example, a finger being removed from a touch screen, or a finger touching the screen again after being removed from the screen).

By “an input device” we mean any device or way by means of which a user can communicate with an interface, input commands, select an object or a group of objects, or act upon the interface in any desired way. A non-exhaustive list of examples of such input devices comprises a computer mouse, a touch screen, a touch pad, multi-sensor screens or peripheral devices, sound, vision.

By “continuous action” we mean the action that continuously takes place between the beginning of the action and the end of the action.

By “user” we mean an entity which interacts with the computer program via the program interface. While in many cases a user will be a human being, it is contemplated that a machine interacting with the computer program interface falls within the scope of an interacting entity.

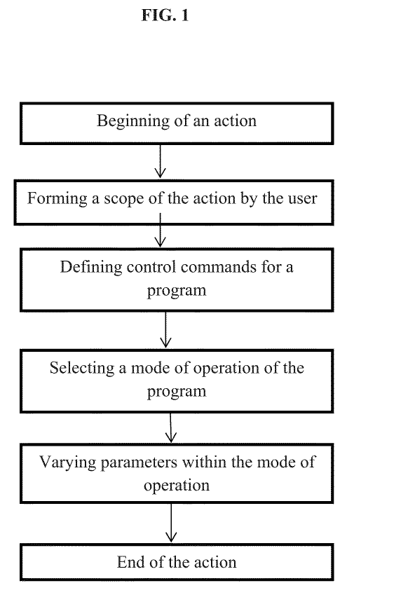

Referring now to FIG. 1, illustrated there is one aspect of the inventive method in which a response of a computer program is controlled by a set of parameters automatically selected in accordance with the number of steps performed or defined by a user by acting upon the program interface with an input device. In that aspect of the inventive method a user invokes a tool of the interface and then automatically changes a set of parameters of that tool based on the movements of the input device performed by the user during the user's acting upon the interface. It is contemplated that instead of invoking a predefined tool, a user can make a selection of the tool during the same step.

A user begins an action by activating or using an input device (10 in FIG. 1). Any input device or means of inputting information or commands into a computer program interface can be used in the inventive method. Moving a cursor on a computer screen, moving one or more fingers on a touch screen of a computer or a mobile device, touching multisensory screens, inputting a command or information via an audio activated interface or a video/visually activated interface are contemplated by the method of the present invention.

The same beginning of an action denoted as 10 in FIG. 1 can be the time when a particular interface tool is selected. An example of such a tool is a selection of a portion or an area of a graphical object with a predetermined ratio between the sides of the area.

After the beginning of the action a user continuously acts upon the interface with the input device. That continuous action can be moving a cursor in a particular way or direction, or moving a finger on a multisensory screen, or giving a specific audio command. During that continuous action the user performs a sequence of movements that define a set of desired parameters of the action. For example, changing an angle of a direction of the movement of the input device can define whether a portion of a selected text is vertically or horizontally oriented. Likewise, performing a predefined move by the input device during the action can define a language of an object that needs to be recognized by optical character recognition.

That sequence of movements performed by the user via the input device during the action defines a scope of the action, as denoted by 11 in FIG. 1. The user-defined scope of the action comprised of the sequence of movements during the continuous action, in turn, automatically defines and selects a set of parameters of that action. In accordance with the selected set of parameters of the action, the tools of the interface of the computer program communicate with that computer program which generates a desired response, as shown by 12 in FIG. 1. In accordance with the automatically selected set of the parameters of the action and the corresponding tools of the interface, the computer program now can select a mode of operation (13 in FIG. 1) and generate a response in accordance with the selected mode of operation (14 in FIG. 1). After the desired response of the program has been generated, the user may end the action (15 in FIG. 1).

It is contemplated by the present invention that the desired responses of the computer program that are based on the settings of interface tools and on the selection of the parameters corresponding to the steps (or moves) of the continuous action can be preset as default settings of the computer program. For example, there can be a default program setting according to which a quick up-and-down motion of an input device may correspond to a choice of language of the image of a document. In another example, a predefined circular motion of the input device will correspond to an indication that the current object is a picture and does not need to be optically recognized. It is also contemplated that in addition to, or instead of such default settings of the computer program, a user can choose the settings of the program and preset which steps of the continuous action will define which parameters of the action and, in turn, the settings of the interface tools and the corresponding response of the program. Likewise, a parameter of an action can correspond to a user-defined or default setting according to which a different interface tool should be invoked by the program.

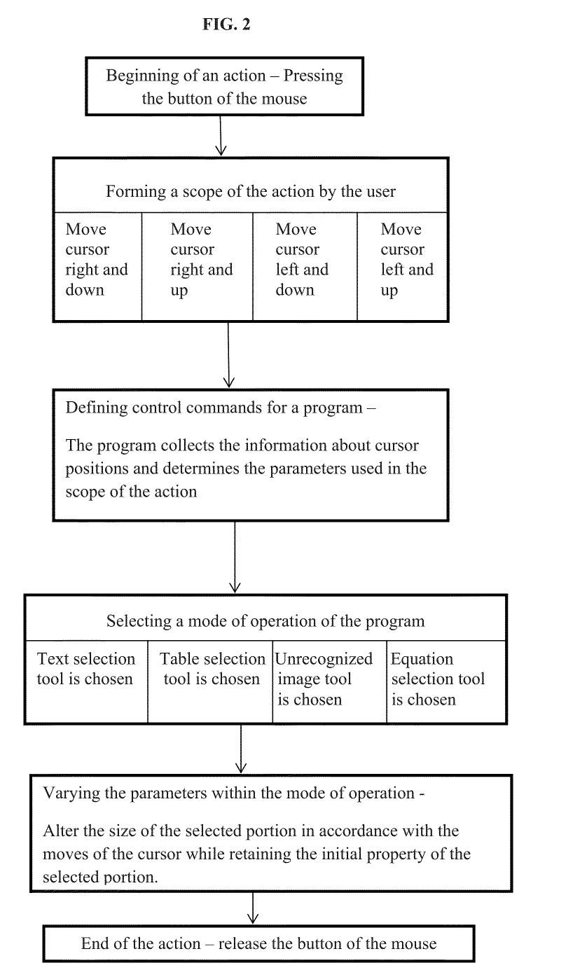

Illustrated in FIG. 2 is an example of the method of the present invention as applied to selecting a portion of the text in the image of the document in an optical character recognition program. By pressing a mouse button a user begins the action (20 in FIG. 2). While selecting the portion of the document image with the text, the user moves the cursor down to the right, then up to the right, then down to the left, then up to the left (21 in FIG. 2), thus, defining and forming a scope of the action. The OCR program collects the information about the positions of the cursor and determines which parameters were defined in the scope of the action during the moves of the user (22 in FIG. 2). For example, in accordance with the defined parameters, the OCR program selects its mode of operation as shown in Table 1:

TABLE 1

| | | |
|---|---|---|
| user moves the cursor | → | text selection tool is |
| down to the right | | chosen (1) |
| user moves the cursor | → | table selection tool is |
| up to the right | | chosen (2) |
| user moves the cursor | → | unrecognized image |
| down to the left | | tool is chosen (3) |
| user moves the cursor | → | equation selection tool |
| up to the left | | is chosen (4) |

Therefore, the OCR program will automatically select the tools (1)-(4) in response to the specific cursor movements of the user (23 in FIG. 2). Then the size of the selected portion of the document image containing the text in the OCR program is changed in accordance with the moves of the cursor before or at the end of the user's action (24 and 25 in FIG. 2, respectively).

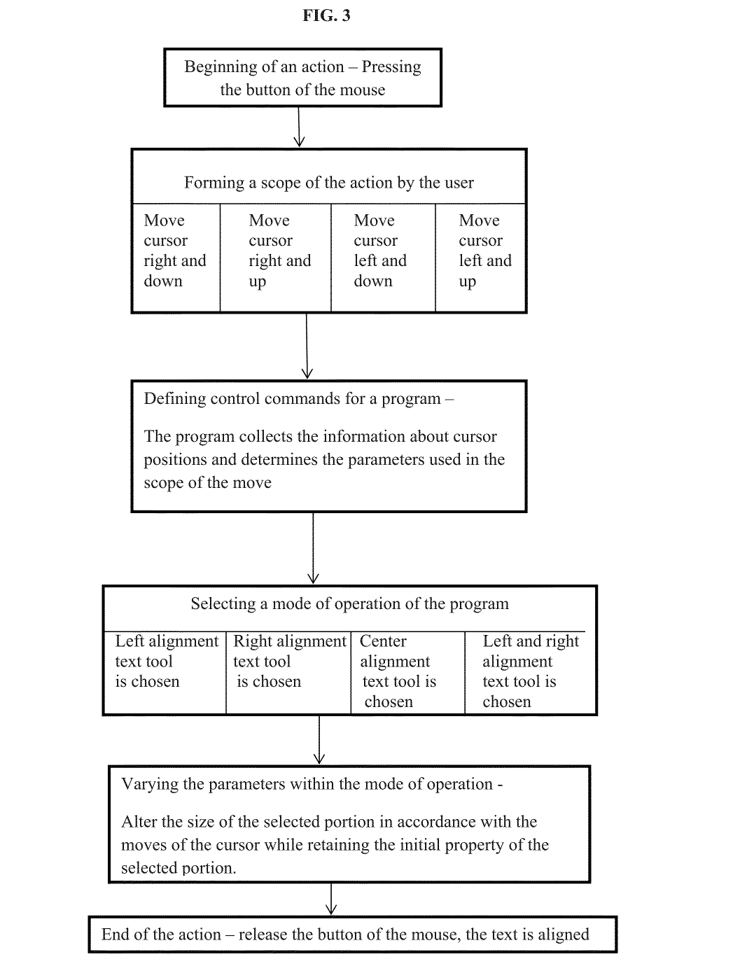

Another example of the method of the present invention as applied to selecting a portion of the text in a text editor program is illustrated in FIG. 3.

By pressing a button a user begins the action (30 in FIG. 3). While selecting the portion of the text, the user moves the cursor down to the right, then up to the right, then down to the left, then up to the left (31 in FIG. 3), thus, defining and forming the scope of the action. The text editing program collects the information about the positions of the cursor during the user's moves and determines which parameters of the action were defined in the scope of the action during the moves of the user (32 in FIG. 3). In accordance with the defined parameters, the text editing program selects its mode of operation as shown in Table 2:

TABLE 2

| | | |
|---|---|---|
| user moves the cursor | → | Left alignment text |
| down to the right | | tool is chosen (5) |
| user moves the cursor | → | Right alignment text |
| up to the right | | tool chosen (6) |
| user moves the cursor | → | Center alignment text |
| down to the left | | tool is chosen (7) |
| user moves the cursor | → | Left and right |
| up to the left | | alignment text tool is |
| | | chosen (8) |

Therefore, the text editing program automatically selects the tools (5)-(8) in response to the specific cursor movements of the user (33 in FIG. 3). Then the size of the selected text portion of in the text editing program is changed in accordance with the moves of the cursor before or at the end of the user's action (34 and 35 in FIG. 3, respectively).

In another example, the method of the present invention is applied to editing an audio file. It is often desired to apply a “fade in” or a “fade out” tool to make a portion of the audio sound louder at the beginning or quieter at the end of a portion of the audio file. When a user moves an input device, for example, from left to right, to select a portion of the sound wave in the audio file, the subsequent position of the input device will be located to the right from the initial position. According to the present invention, that subsequent location of the input device will automatically define selection of the “fade in” tool for that selected portion of the sound wave. Selection of the “fade in” tool and the actual application of that tool will take place automatically during the same action in which the user selects a portion of the audio file. The selected portion of the audio file will be faded in by the time the user finishes selecting that portion. Likewise, when the user moves the input device from right to left to select a portion of the audio file, then the subsequent position of the input device will be located to the left from its initial position. That subsequent location of the input device will automatically define selecting the “fade out” tool to apply to the selected portion of the sound wave. Similarly to the above-described examples, selecting the fade out tool takes place during the same action in which the user selects a portion of the audio file before ending the action by releasing the button, for example.

In more general terms, an action, comprised of the beginning, the scope and the end of the action, corresponds to a set of rules of processing of that a portion of a document image (or an just image, or text, or a multimedia file selected by the user) to which that set of rules pertains. That action defines a function pertaining to the changing of the properties of an object. Such properties pertaining to the object can be, for example, a change of language in a text, contrast of an image, the direction and angling of a text.

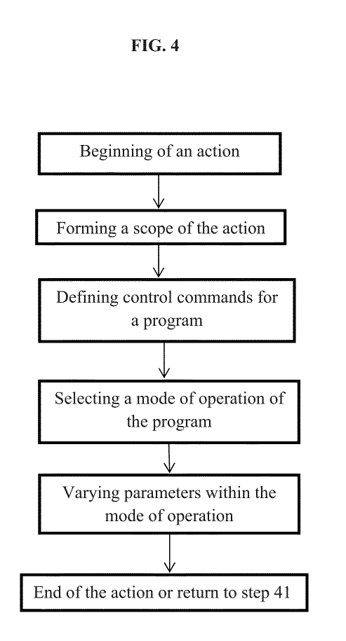

Referring now to FIG. 4, illustrated there is another aspect of the inventive method in which a user-selected tool of the interface can change to a different user-selected tool depending on the scope of the action at a certain moment of the action. Such changes of the selected interface tool can occur continuously or discretely. More specifically, the user can not only automatically select a set of parameters corresponding to a continuous action, but also select or change the interface tool during the same continuous action. A predefined step/move of that continuous action will correspond to a selection of a different interface tool. For example, if a user started the action with a rectangular selection tool, the user can switch to a circular selection tool while still moving the cursor in the course of the same action. That aspect of the inventive method does not require the user to move the cursor to a toolbar, select a different setting from the toolbar, choose that setting and return to the selection tool.

The same beginning of an action denoted as 40 in FIG. 4 is the step when a particular interface tool is selected. As it has been described above, an example of such a tool can be a selection of a portion or an area of a graphical object with a predetermined ratio between the sides of the area.

After the beginning of the action a user continuously acts upon the interface with the input device. That continuous action can be moving a cursor in a particular way or direction, or moving a finger on a multisensory screen, or giving a specific voice command. During that continuous action the user performs a sequence of movements that define a set of desired parameters of the action. For example, changing an angle of a direction of the movement of the input device can define whether a portion of a selected text is vertically or horizontally oriented. Likewise, performing a predefined move by the input device during the action can choose a language of an object that needs to be recognized by optical character recognition.

That sequence of movements performed by the user via the input device during the action defines a scope of the action, as denoted by 41 in FIG. 4. The user-defined scope of the action comprised of the sequence of movements during the continuous action, in turn, automatically defines and selects a set of parameters of the action upon which the computer program can generate a desired response, as shown by 42 in FIG. 4. In accordance with the automatically selected set of parameters of the acting and the corresponding settings of the interface tool the computer program now can select a mode of operation (43 in FIG. 4) and generate a response in accordance with the selected mode of operation (44 in FIG. 4). After the desired response of the program has been generated, the user ends the action, or alternatively, continues the action by returning to step 41 and performing subsequent steps with a different interface tool (45 in FIG. 4). Selection of a different interface tool is based on the state of the action at a predetermined time.

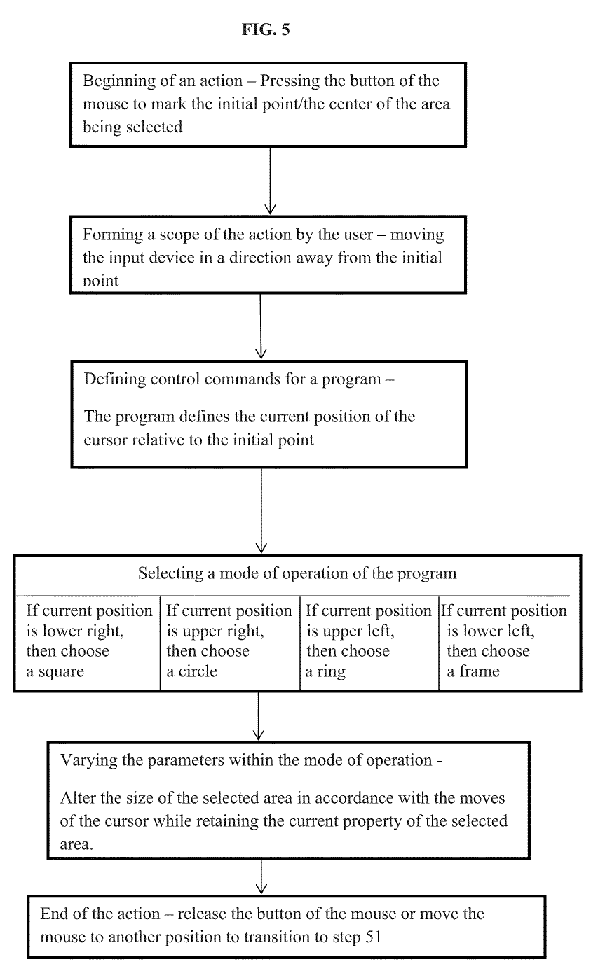

Illustrated in FIG. 5 is an example of the method generally depicted in FIG. 4 as applied to selecting a centrally symmetrical area of different geometry in an object or a group of objects. By pressing a button a user begins the action (50 in FIG. 5) and indicates an initial point, which, in this example, is the central point of the centrally symmetrical area to be selected. Then the user moves the cursor of the input device in a direction away from the central point (51 in FIG. 5), thus, defining and forming the scope of the action. Then the program detects the current position of the cursor relative to the central point and, thus, collects the information about the position of the cursor and determines which parameters of the action were defined in the scope of the action during the moves of the user (52 in FIG. 5). In accordance with the defined parameters, the program selects its mode of operation as shown in Table 3 (53 in FIG. 5):

TABLE 3

| | | |
|---|---|---|
| If the current position | → | Choose a square |
| is lower right relative | | |
| to the central point | | |
| If the current position | → | Choose a circle |
| is upper right relative | | |
| to the central point | | |
| If the current position | → | Choose a ring |
| is upper left relative | | |
| to the central point | | |
| If the current position | → | Choose a frame |
| is lower left relative | | |
| to the central point | | |

If a specific tool (for example, a square) is chosen based on the position of the cursor relative to the central point, then the parameter corresponding to the size of the selected square tool can be selected in the same scope of the action by moving the cursor during the same continuous action (54 in FIG. 5) . At the end of the action the user has a choice of simply ending the action or, alternatively, moving the cursor to another position on the screen to select a different tool (for example, a frame) based on the location of that other position relative to the central point (55 in FIG. 5). After selecting a different tool, the described steps of the method can be performed again with respect to the different tool.

While one of the parameters (a position of the cursor relative to the selected central point) corresponds to the type of an interface tool (a square, a circle, a ring, or a frame in the described example), the same continuous action allows the user to continue to control the response of the program by selecting the size of the selected tool. The above-described example illustrates that the present method can be performed in a cyclical mode when the set of parameters of a selected tool as defined by the scope of the action determines not only the parameters of the selected tool, but also the type of the tool. The described method makes it easier for a user to generate a response from a program, as well as to control the response of the program, by automatically selecting a set of parameters of the action in the continuous action without the need to repeatedly select various parameters of the interface by performing repeated quick motions with an input device and to repeatedly search for and select numerous desired properties of the interface in toolbars, pull-down menus, and pop-up menus.

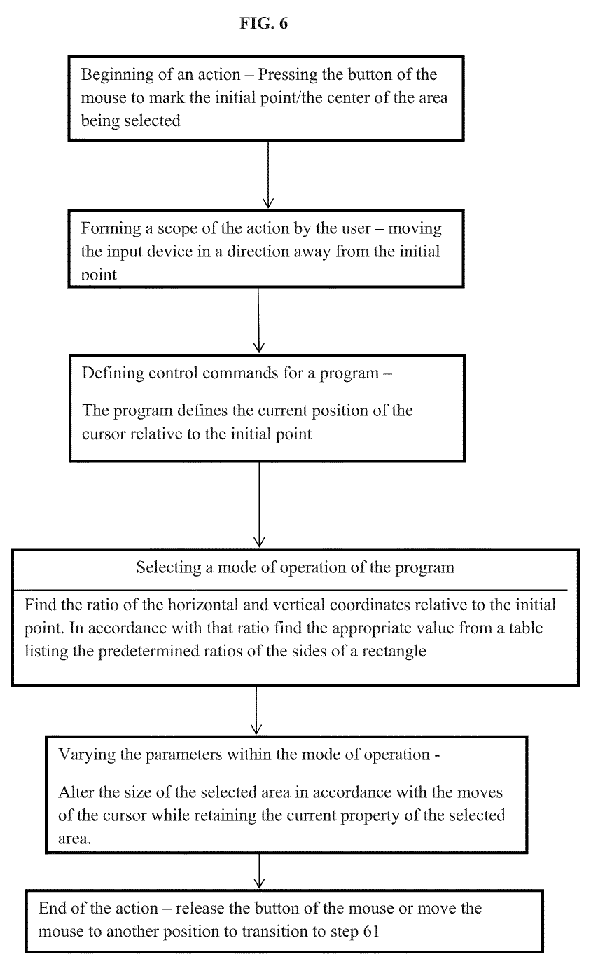

Illustrated in FIG. 6 is another example of the method generally depicted in FIG. 4 as applied to selecting various rectangular areas with a predetermined ratio of its sides. By pressing a button a user begins the action (60 in FIG. 6) and indicates an initial point of the rectangular area to be selected. Then the user moves the cursor of the input device in a direction away from the initial point (61 in FIG. 6), thus, defining and forming the scope of the action. Then the program detects the current position of the cursor relative to initial point and, thus, collects the information about the position of the cursor and determines which parameters were defined in the scope of the action during the moves of the user (62 in FIG. 6). In accordance with the defined parameters, the program selects its mode of operation as follows (63 in FIG. 6): find the ratio of the horizontal and vertical coordinates relative to the initial point and the, according to that ratio, find the closest value of the ratio from a table listing the predetermined ratios of the sides of a rectangle.

If a specific tool (for example, a rectangle with a specific side ratio) is chosen based on the position of the cursor relative to the initial point, then the parameter corresponding to the size of the selected rectangular tool can be selected in the same scope of the action by moving the cursor during the same continuous action (64 in FIG. 6). At the end of the action the user has a choice of simply ending the action or, alternatively, move the cursor to another position on the screen to select a different rectangular tool (characterized by a different ration of its sides) based on the location of that other position relative to the initial point (65 in FIG. 6). After selecting a different rectangular tool, the described steps of the method can be performed again with respect to the different tool.

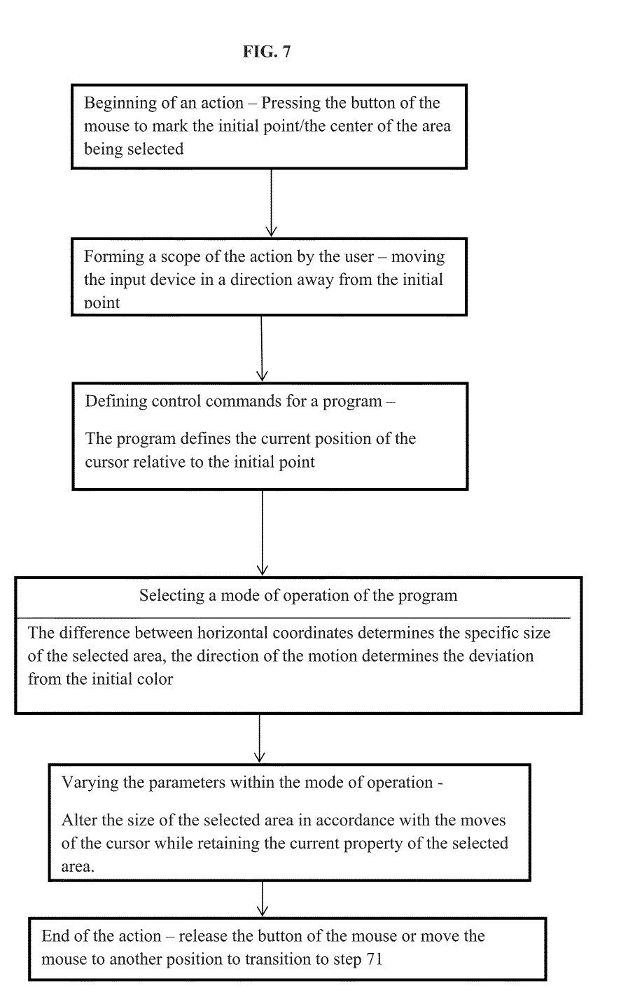

Illustrated in FIG. 7 is yet another example of the method generally depicted in FIG. 4 as applied to an image processing program. In that example a set of two properties of an interface tool is continuously controlled by a set of two parameters. A user of such a program might need to select an image area in which the pixels of similar color shades are located within a predetermined distance relative to an initial point. Such a tool can be used in image processing programs, for example, for correcting skin imperfections on a photograph of a human face. In that example the set of parameters is comprised of a specific area size and the permitted deviation from the color of a selected initial point.

By pressing a button a user begins the action (70 in FIG. 7) and indicates an initial point of the image area to be selected. Then the user moves the cursor of the input device in a direction away from the initial point (71 in FIG. 7), thus, defining and forming the scope of the action. Then the program detects the current position of the cursor relative to initial point and, thus, collects the information about the position of the cursor and determines which parameters were defined in the scope of the action during the moves of the user (72 in FIG. 7). In accordance with the defined parameters, the program selects its mode of operation as follows (73 in FIG. 7): the difference between the horizontal coordinates determines the specific size of the selected area, while the direction (up or down) of the motion of the cursor determines the deviation from the color of a selected initial point.

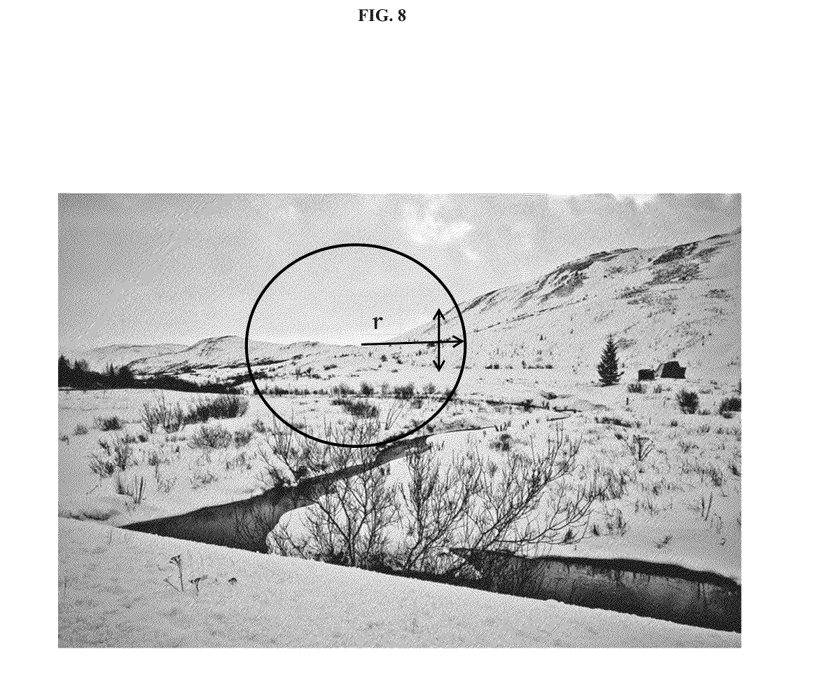

Illustrated in FIG. 8 is yet another example of an embodiment of the present invention in an image processing application. In that embodiment a user selects a portion of a picture (a photograph in FIG. 8). Included in that portion are the pixels characterized by a set of predefined parameters, such as, for example, the pixels' distance from an initial pixel indicated by the user, and the pixel's similarity in color within a desired color spectrum. The user starts with using an input device, such as a mouse or a finger on a multisensory screen, to select and indicate an initial pixel in the photo. The user then moves the input device horizontally to the right from the initial pixel, as shown by the horizontal arrow in FIG. 8, and automatically selects the size of the selected portion, shown as radius [symbol] of a circle with the center in the initial pixel. Together with moving the input device along the direction of the shown horizontal arrow, the user changes the capture range of the color spectrum relative to the color of the initial pixel by moving the input device clockwise or counterclockwise, as shown by the double-headed arrow in FIG. 8. The program's response regarding whether to include a particular pixel into the selected portion is determined by the distance [symbol] between that particular pixel and the initial pixel, as well as by their similarity (or difference) in color. In this example each pixel is assigned a coefficient reflecting the degree to which each pixel fits the distance and similarity of color criteria of the portion being selected by the user. In the described example the method of the present invention allows the user to control the two above-referenced parameters of the action during the action. The changes in the selected portion are seen by the user in real time to visually assist the user in selection the portion of the picture. The described embodiment gives the user the helpful ability to change the pixels' brightness, contrast, or applying retouching or touch up tools during the same action.

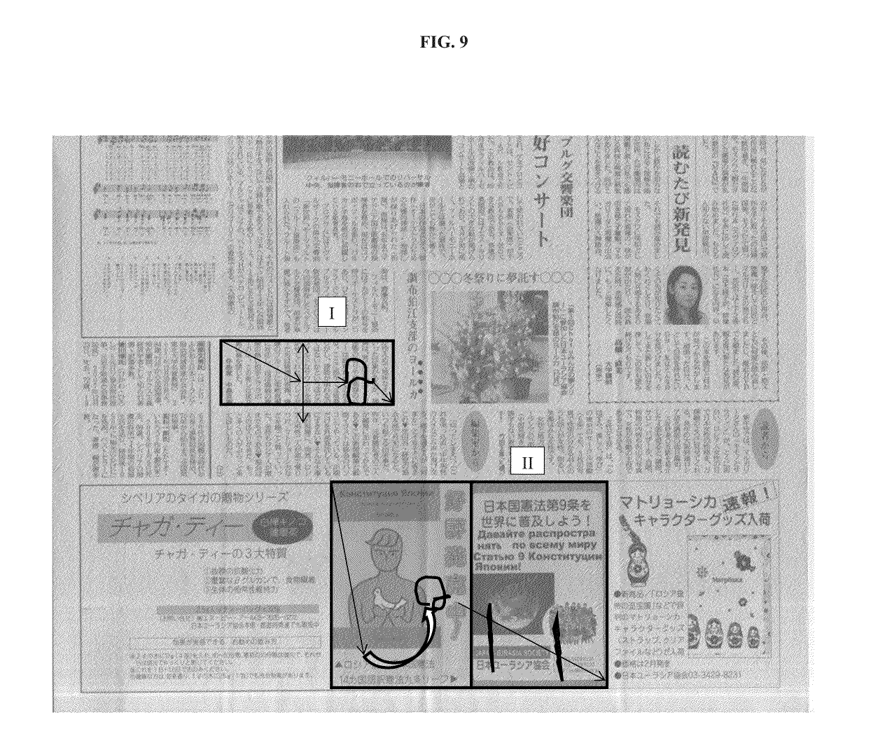

Referring now to FIG. 9, shown there are two examples of how various predefined steps of a user's action define a set of parameters of the action and, in turn, define the settings of the corresponding interface tool, as well as the choice of the tool.

In example I of FIG. 9 a user starts from the upper left corner and uses a rectangular interface tool to select a portion of an image of a newspaper. The first step of the action occurs according to the first arrow, starting from the upper left. During that step the rectangular selection tool is being applied to the image. The second step of the same action is illustrated by the double-headed arrow corresponding to the up-and-down movement of the user's cursor. That second up-and-down step means that the text is vertically oriented and that the parameter of the vertical orientation of the text would be automatically selected for the rectangular interface selection tool. As the user continues to move the cursor horizontally (the horizontal arrow in example I), the user selects the parameter corresponding to the Japanese language by continuing moving the cursor along the line looking like the letter “J”. That step of the action results in the Japanese language parameter being selected and, in turn, associated with the interface tool. The program will, then, be set up to do an OCR process of the Japanese language. Finally, the user moves the cursor diagonally down, finishing the selection of the portion of the image and ending the action.

In example II of FIG. 9 a user starts from the upper left corner and uses a rectangular interface tool to select a portion of an image of a newspaper. The first step of the action occurs according to the first arrow, starting from the upper left and facing sharply down. During that step the rectangular selection tool with a certain ratio of its sides is being applied to the image. Then, in the continuous action, the user changes the angle of the move and continues up and to the right. That step of the action corresponds to the parameter changing the previous ratio of the sides of the rectangle and changing the initial rectangle to a different, larger rectangle with a different ratio of its sides. The subsequent circular motion of the cursor corresponds to the step of the action which indicates that the cursor is now over the picture that need not be recognized by the program, such as a text recognition program. The action then continues to the lower right corner of the rectangular selection with two distinct up-down movements of the cursor occurring during that move to indicate that the English and Russian languages are present in the selected portion and should be recognized as such languages. The parameters corresponding to the Russian and Japanese languages would be selected during the action and associated with the interface tool to generate the desired response from the program. That desired response, for example, would be optically recognizing the image within the larger rectangle containing the Japanese and Russian languages, but excluding the picture.

The method of the present invention is applicable to all kinds of objects or a set of objects, such as, for example, the objects comprising text, graphics, audio and video, as well as combinations thereof. In many cases an object comprises a text portion and a portion with graphical material, or it can be a multimedia object that embeds text, graphics and audio, or text, graphics, audio and video material. The method of the present invention is applicable to all objects or a set of objects in which a portion or a block can be selected by a user.

Having described the invention in detail and be reference to specific embodiments thereof, it will be apparent to those of average skill in the art that numerous modification and variations are possible without departing from the spirit and scope of the invention.

1. A method of automatically selecting parameters of an action , the method comprising:
using an input device to start an action upon the interface and selecting an interface tool corresponding to a beginning of the action;
continuously acting upon the interface with the input device during the action to define a scope of the action, the scope of the action corresponding to a set of settings of the interface tool, the settings of the interface tool corresponding to the set of parameters of the action being defined by steps of the continuous action of the input device;
automatically selecting a set of parameters of the action by identifying the steps of the continuous action of the input device during the action;
selecting a response of a computer program, the response corresponding to the settings of the interface tool operating in accordance with the automatically selected set of parameters of the action;
generating the response of the computer program, the response being controlled by the settings of the interface tool; and
ending the action of the input device upon the interface.

2. The method according to claim 1, wherein selecting the interface tool further comprises selecting a portion of an object or a portion of a group of objects.

3. The method of claim 1, wherein using the input device comprises using a peripheral device, a touch screen, a multisensory screen, an audio input, or a video input.

4. The method of claim 1, wherein selecting the response of the computer program comprises selecting the response of a text processing program, an image processing program, an audio processing program, a video processing program, a program working with objects in a spatial reference frame, a program working with a three-dimensional model, or any combinations thereof.

5. The method of claim 4, wherein the computer program is a CAD program.

6. The method of claim 1, wherein the steps of the continuous action of the input device comprise changing an angle of a motion of the input device, changing a direction of the motion of the input device, changing a type of the motion, changing an intensity or velocity of an input of the input device, a tilt of a stylus of a graphic pad, graphic tablet, drawing tablet, or any combinations thereof.

7. The method of claim 1, wherein continuously acting upon the interface with the input device during the action is performed by a human user.

8. The method of claim 1, wherein continuously acting upon the interface with the input device during the action is performed by a machine or a device.

9. A method of automatically selecting parameters of an action, the method comprising:
(a) using an input device to start an action upon the interface and selecting an interface tool corresponding to a beginning of the action;
(b) continuously acting upon the interface with the input device during the action to define a scope of the action, the scope of the action corresponding to a set of settings of the interface tool, the settings of the interface tool corresponding to the set of parameters of the action being defined by steps of the continuous action of the input device;
(c) automatically selecting a set of parameters of action by identifying the steps of the continuous action of the input device during the action;
(d) selecting a response of a computer program, the response corresponding to the settings of the interface tool operating in accordance with the automatically selected set of parameters of the action;
(e) generating the response of the computer program, the response being controlled by the settings of the interface tool; and
(f) ending the action of the input device upon the interface or alternatively continuing the action by selecting a different interface tool and performing steps (b)-(f) for the different interface tool.

10. The method of claim 9, selecting the interface tool further comprises selecting a portion of an object or a portion of a group of objects.

11. The method of claim 9, wherein continuing the action by selecting the different interface tool is determined by a state of the action at a predetermined time.

12. The method of claim 7, wherein using the input device comprises using a peripheral device, a touch screen, a multisensory screen, an audio input, or a video input.

13. The method of claim 9, wherein selecting the response of the computer program comprises selecting the response of a text processing program, an image processing program, an audio processing program, a video processing program, a program working with objects in a spatial reference frame, a program working with a three-dimensional model, or any combinations thereof.

14. The method of claim 13, wherein the computer program is a CAD program.

15. The method of claim 9, wherein the steps of the continuous action of the input device comprise changing an angle of a motion of the input device, changing a direction of the motion of the input device, changing a type of the motion, changing an intensity or velocity of an input of the input device, a tilt of a stylus of a graphic pad, graphic tablet, drawing tablet, or any combinations thereof.

16. A system comprising:
a processor and a memory coupled to the processor, the memory comprising an application which when executed causes the system to perform a set of instructions for automatically selecting parameters of an action, the instructions comprising: using an input device to start an action upon the interface and selecting an interface tool corresponding to a beginning of the action; continuously acting upon the interface with the input device during the action to define a scope of the action, the scope of the action corresponding to a set of settings of the interface tool, the settings of the interface tool corresponding to the set of parameters of the action being defined by steps of the continuous action of the input device; automatically selecting a set of parameters of the action by identifying the steps of the continuous action of the input device during the action; selecting a response of a computer program, the response corresponding to the settings of the interface tool operating in accordance with the automatically selected set of parameters of the action; generating the response of the computer program, the response being controlled by the settings of the interface tool; and ending the action of the input device upon the interface.

17. A physical, non-transitory computer storage medium having stored thereon a program which when executed by a processor, perform instructions for automatically selecting parameters of an action, the instructions comprising: using an input device to start an action upon the interface and selecting an interface tool corresponding to a beginning of the action; continuously acting upon the interface with the input device during the action to define a scope of the action, the scope of the action corresponding to a set of settings of the interface tool, the settings of the interface tool corresponding to the set of parameters of the action being defined by steps of the continuous action of the input device; automatically selecting a set of parameters of the action by identifying the steps of the continuous action of the input device during the action; selecting a response of a computer program, the response corresponding to the settings of the interface tool operating in accordance with the automatically selected set of parameters of the action; generating the response of the computer program, the response being controlled by the settings of the interface tool; and ending the action of the input device upon the interface.

18. A system comprising:
a processor and a memory coupled to the processor, the memory comprising an application which when executed causes the system to perform a set of instructions for automatically selecting parameters for an action, the method comprising:
(a) using an input device to start an action upon the interface and selecting an interface tool corresponding to a beginning of the action;
(b) continuously acting upon the interface with the input device during the action to define a scope of the action, the scope of the action corresponding to a set of settings of the interface tool, the settings of the interface tool corresponding to the set of parameters of the action being defined by steps of the continuous action of the input device;
(c) automatically selecting a set of parameters of action by identifying the steps of the continuous action of the input device during the action;
(d) selecting a response of a computer program, the response corresponding to the settings of the interface tool operating in accordance with the automatically selected set of parameters of the action;
(e) generating the response of the computer program, the response being controlled by the settings of the interface tool; and
(f) ending the action of the input device upon the interface or alternatively continuing the action by selecting a different interface tool and performing steps (b)-(f) for the different interface tool.

19. A physical, non-transitory computer storage medium having stored thereon a program which when executed by a processor, perform instructions for automatically selecting parameters for a computer program interface, the method comprising:
(a) using an input device to start an action upon the interface and selecting an interface tool corresponding to a beginning of the action;
(b) continuously acting upon the interface with the input device during the action to define a scope of the action, the scope of the action corresponding to a set of settings of the interface tool, the settings of the interface tool corresponding to the set of parameters of the action being defined by steps of the continuous action of the input device;
(c) automatically selecting a set of parameters of action by identifying the steps of the continuous action of the input device during the action;
(d) selecting a response of a computer program, the response corresponding to the settings of the interface tool operating in accordance with the automatically selected set of parameters of the action;
(e) generating the response of the computer program, the response being controlled by the settings of the interface tool; and
(f) ending the action of the input device upon the interface or alternatively continuing the action by selecting a different interface tool and performing steps (b)-(f) for the different interface tool.
